(19) United States
(12) Patent Application Publication
(10) Pub. No.: US 2002/0008716 A1
(43) Pub. Date: Jan. 24, 2002

(54) System and method for controlling expression characteristics of a virtual agent

(76) Inventors: Robert A. Colburn, Renton, WA (US); Michael F. Cohen, Seattle, WA (US); Steven M. Drucker, Bellevue, WA (US)

Correspondence Address: LEE & HAYES PLLC, 421 W RIVERSIDE AVENUE SUITE 500, SPOKANE, WA, 99201

(21) Appl. No.: 09/737,530

(22) Filed: Dec. 13, 2000

Related U.S. Application Data
(60) Provisional application No. 60/220,475, filed on Jul. 21, 2000.

(51) Int. Cl. G06F 13/00

(52) U.S. Cl. 345/706; 345/753

(57) ABSTRACT

A method is presented comprising rendering a virtual character to interface with at least a user, and controlling one or more anatomical attributes of the virtual character based, at least in part, on a scientifically-based model of physically expressive behavior for that anatomical attribute.

This application claims express priority to U.S. Provisional Application No. 60/220,475 filed on Jul. 21, 2000 by Colburn, et al. entitled “A System and Method for Controlling Eye Gaze Characteristics of a Virtual Agent”.

### TECHNICAL FIELD

This invention generally relates to virtual agents and, more particularly, to a system and method for controlling one or more expressive characteristics of a virtual agent to improve the conversational experience with another conversant.

### BACKGROUND

Recent advances in computing power and related technology have fostered the development of a new generation of powerful software applications. Gaming applications, communications applications, and multimedia applications have particularly benefited from increased processing power and clocking speeds. The ability to create and render life-like characters has added personality to gaming applications, modeling applications, and the like. This technology has also morphed into communication applications wherein the anthropomorphic characters are utilized to represent video conference participants as virtual agents, or proxies, in the display to other conference participants.

The detail of these life-like, anthropomorphic characters is impressive indeed, and it is this level of detail that captures and holds the attention of users. In certain instances, e.g., role playing gaming applications, it is as if you are watching and directing a movie of real “people”, all of which respond in some fashion to your every whim. Those skilled in the art will appreciate, however, that it is difficult to render such life-like characters and even more difficult to give them physically expressive communication attributes. There is a broad body of literature on the role of the eyes in facilitating human interaction and communication. Eye gaze, for example, is often employed by humans during the course of conversation to help control the flow of conversation. A person listening to a speaker uses their eyes to indicate whether they are paying attention to the speaker. Similarly, the speaker uses eye gaze to determine whether the listener(s) are paying attention and to denote that they are about to “hand-off” the role as speaker to a listener. The importance of such non-verbal, physically expressive communication is easily illustrated by reflecting on an initial telephone conversation between two persons who have never met. In such instances, the conversation is often clumsy, containing breaks of silence in the conversation because it is unclear from the verbal context alone who is to proceed next as speaker. Similarly, in gaming applications, while the characters themselves are impressive, the lack of physically expressive behavior acts as a barrier to the full emotional immersion in the game by the user.

Humans sub-consciously use a number of factors in controlling their eye gaze including, the number of people participating in the conversation, the content of the conversation, external distractions to the conversation, etc. Moreover, research suggests that eye gaze behavior varies with the age of the participants, the gender and the culture of the participants. Despite the important role of such non-verbal communication and communication cues, the number and complexity of the factors involved to animate such physically expressive behavior has heretofore been programmatically prohibitive. As a result, prior art virtual character generation systems have failed to adequately model such physically expressive behavioral attributes, thereby limiting the effectiveness of applications which purport to foster communications utilizing such virtual characters (e.g., role playing games, video conferencing applications, and the like).

A common prior art approach was to simply modify certain physically expressive attributes on a fixed, periodic basis, regardless of context or content of the conversation. In the area of eye gaze, for example, a common prior art approach was to simply make the virtual character “blink” on a periodic basis, in an attempt to “humanize” the character. However, where the goal is to enable the user to forget that they are interacting with a lifeless character, and converse with the anthropomorphic character in a “normal” fashion, such prior art techniques fall well short of the goal.

Thus, a system and method for controlling physically expressive attributes of a virtual character is presented, unencumbered by the deficiencies and limitations commonly associated with the prior art.

### SUMMARY

This invention concerns a system and method for controlling one or more expressive characteristics of an anthropomorphic character. In accordance with a first example embodiment, a method is presented comprising rendering a virtual character to interface with at least a user, and controlling one or more anatomical attributes of the virtual character based, at least in part, on a scientifically-based model of physically expressive behavior for that anatomical attribute. According to one example implementation, an eye gaze attribute of physically expressive behavior is modeled, wherein the rendered eye gaze feature of the virtual character is controlled in accordance with an eye gaze model that reflects human eye gaze behavior. According to additional aspects of the present invention, the scientifically-based model includes such factors as culture, age of user(s), conversational content, gender, and the like, to further involve the user in the conversation.

### BRIEF DESCRIPTION OF THE DRAWINGS

The same reference numbers are used throughout the figures to reference like components and features.

FIG. 1 is a block diagram of a computer system incorporating the teachings of the present invention;

FIG. 2 is a block diagram of an example virtual character generation system including a model for physically expressive behavior, according to one example implementation of the invention;

FIG. 3 illustrates a flow chart of an example method for controlling physically expressive behavior of a virtual character, according to one embodiment of the present invention;

FIG. 4 is a hierarchical state diagram for controlling eye gaze behavior of a virtual character in a two-person conversation, according to one aspect of the present invention;

FIG. 5 is a hierarchical state diagram for controlling eye gaze behavior of a virtual character in a multi-party conversation, according to one aspect of the present invention;

FIG. 6 is a block diagram of an example video conferencing system incorporating the teachings of the present invention, in accordance with one example embodiment;

FIG. 7 is a graphical illustration of an example video conferencing application display utilizing one or more innovative aspects of the virtual character rendering system, according to one example embodiment of the present invention; and

FIG. 8 is a graphical illustration of an example storage medium including instructions which, when executed, implement the teachings of the present invention, according to one embodiment of the present invention.

### DETAILED DESCRIPTION

This invention concerns a system and method for controlling physically expressive attributes of a virtual character. For ease of illustration, and not limitation, the inventive aspects of the system and method for controlling one or more expressive attributes of an anthropomorphic character will be introduced in the context of a virtual agent, acting on behalf of a conversant in a teleconference. In this regard, the claimed invention builds upon one or more inventive aspects disclosed in co-pending U.S. Application No. TBD, entitled “A System and Method for Automatically Adjusting Gaze and Head Orientation for Video Conferencing” filed on TBD, by TBD and commonly assigned to the assignee of the present application, the disclosure of which is hereby incorporated herein by reference. It is to be appreciated, however, given the discussion below, that these same inventive aspects may well be applied to a number of technologies utilizing anthropomorphic characters to interface with human participants, e.g., gaming technology, educational applications, and the like.

In the discussion herein, the invention is described in the general context of computer-executable instructions, such as program modules, being executed by one or more conventional computers. Generally, program modules include routines, programs, objects, components, data structures, etc. that perform particular tasks or implement particular abstract data types. Moreover, those skilled in the art will appreciate that the invention may be practiced with other computer system configurations, including hand-held devices, personal digital assistants, multiprocessor systems, microprocessor-based or programmable consumer electronics, network PCs, minicomputers, mainframe computers, and the like. In a distributed computer environment, program modules may be located in both local and remote memory storage devices. It is noted, however, that modification to the architecture and methods described herein may well be made without deviating from spirit and scope of the present invention.

Example Computer System

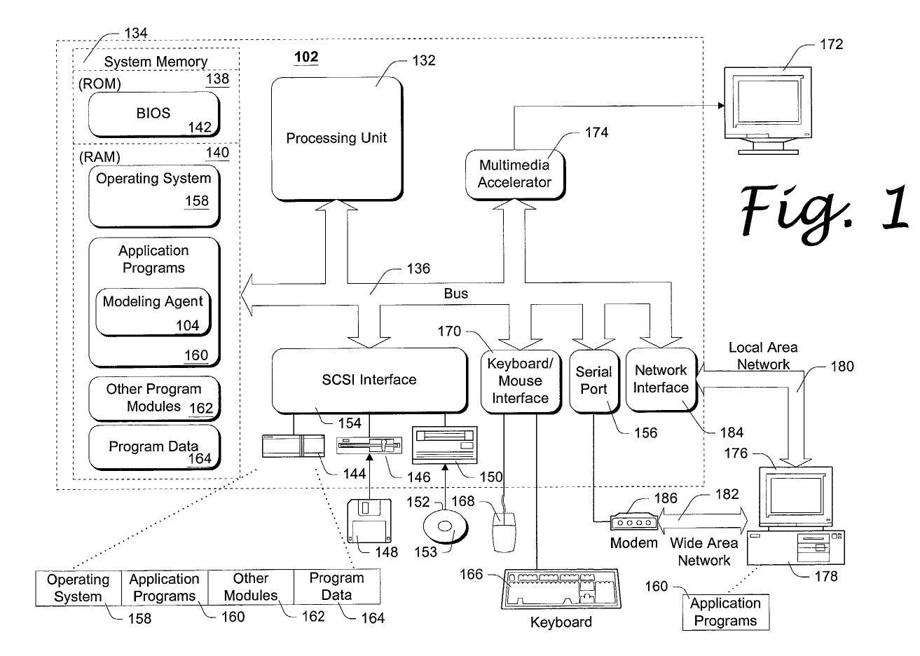

FIG. 1 illustrates an example computer system 102 including a modeling agent 104, which controls one or more anatomical features of a rendered anthropomorphic (or, virtual) character to accurately reflect one or more physically expressive attributes in response to a conversation with one or more users based, at least in part, on a scientifically based model of human physically expressive behavior for the anatomical feature(s). More particularly, in accordance with an example implementation, modeling agent 104 renders a virtual character that accurately reflects the eye gaze expressive attribute of the character, in response to a conversation in which the character is participating. In this regard, a virtual character rendered by innovative modeling agent 104 provides accurate physically expressive conversational cues, enabling more relaxed interaction with the character by the human conversation participant(s).

It should be appreciated that although depicted as a separate, stand alone application in FIG. 1, modeling agent 104 may well be implemented as a function of an application, e.g., a gaming application, a multimedia application, a personal assistant/representative (“avatar”) application, a video conferencing application, and the like. It will be evident, from the discussion to follow, that computer 102 is intended to represent any of a class of general or special purpose computing platforms which, when endowed with the innovative modeling agent 104, implement the teachings of the present invention in accordance with the first example implementation introduced above. Moreover, although depicted herein as a software application, computer system 102 may alternatively support a hardware implementation of modeling agent 104 as well, e.g., as an application specific integrated circuit (ASIC), programmable logic array (PLA), dedicated microcontroller, etc. In this regard, but for the description of modeling agent 104, the following description of computer system 102 is intended to be merely illustrative, as computer systems of greater or lesser capability may well be substituted without deviating from the spirit and scope of the present invention.

As shown, computer 102 includes one or more processors or processing units 132, a system memory 134, and a bus 136 that couples various system components including the system memory 134 to processors 132.

The bus 136 represents one or more of any of several types of bus structures, including a memory bus or memory controller, a peripheral bus, an accelerated graphics port, and a processor or local bus using any of a variety of bus architectures. The system memory includes read only memory (ROM) 138 and random access memory (RAM) 140. A basic input/output system (BIOS) 142, containing the basic routines that help to transfer information between elements within computer 102, such as during start-up, is stored in ROM 138. Computer 102 further includes a hard disk drive 144 for reading from and writing to a hard disk, not shown, a magnetic disk drive 146 for reading from and writing to a removable magnetic disk 148, and an optical disk drive 150 for reading from or writing to a removable optical disk 152 such as a CD ROM, DVD ROM or other such optical media. The hard disk drive 144, magnetic disk drive 146, and optical disk drive 150 are connected to the bus 136 by a SCSI interface 154 or some other suitable bus interface. The drives and their associated computer-readable media provide nonvolatile storage of computer readable instructions, data structures, program modules and other data for computer 102.

Although the exemplary environment described herein employs a hard disk 144, a removable magnetic disk 148 and a removable optical disk 152, it should be appreciated by those skilled in the art that other types of computer readable media which can store data that is accessible by a computer, such as magnetic cassettes, flash memory cards, digital video disks, random access memories (RAMs) read only memories (ROM), and the like, may also be used in the exemplary operating environment.

A number of program modules may be stored on the hard disk 144, magnetic disk 148, optical disk 152, ROM 138, or RAM 140, including an operating system 158, one or more application programs 160 including, for example, the innovative modeling agent 104 incorporating the teachings of the present invention, other program modules 162, and program data 164 (e.g., resultant language model data structures, etc.). A user may enter commands and information into computer 102 through input devices such as keyboard 166 and pointing device 168. Other input devices (not specifically denoted) may include a microphone, joystick, game pad, satellite dish, scanner, or the like. These and other input devices are connected to the processing unit 132 through an interface 170 that is coupled to bus 136. A monitor 172 or other type of display device is also connected to the bus 136 via an interface, such as a video adapter 174. In addition to the monitor 172, personal computers often include other peripheral output devices (not shown) such as speakers and printers.

As shown, computer 102 includes networking facilities with which to operate in a networked environment using logical connections to one or more remote computers, such as a remote computer 176. The remote computer 176 may be another personal computer, a personal digital assistant, a server, a router or other network device, a network “thin-client” PC, a peer device or other common network node, and typically includes many or all of the elements described above relative to computer 102, although only a memory storage device 178 has been illustrated in FIG. 1.

As shown, the logical connections depicted in FIG. 1 include a local area network (LAN) 180 and a wide area network (WAN) 182. Such networking environments are commonplace in offices, enterprise-wide computer networks, Intranets, and the Internet. In one embodiment, remote computer 176 executes an Internet Web browser program such as the “Internet Explorer” Web browser manufactured and distributed by Microsoft Corporation of Redmond, Washington to access and utilize online services.

When used in a LAN networking environment, computer 102 is connected to the local network 180 through a network interface or adapter 184. When used in a WAN networking environment, computer 102 typically includes a modem 186 or other means for establishing communications over the wide area network 182, such as the Internet. The modem 186, which may be internal or external, is connected to the bus 136 via a input/output (I/O) interface 156. In addition to network connectivity, I/O interface 156 also supports one or more printers 188. In a networked environment, program modules depicted relative to the personal computer 102, or portions thereof, may be stored in the remote memory storage device. It will be appreciated that the network connections shown are exemplary and other means of establishing a communications link between the computers may be used.

Generally, the data processors of computer 102 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the innovative steps described below in conjunction with a microprocessor or other data processor. The invention also includes the computer itself when programmed according to the methods and techniques described below. Furthermore, certain sub-components of the computer may be programmed to perform the functions and steps described below. The invention includes such sub-components when they are programmed as described. In addition, the invention described herein includes data structures, described below, as embodied on various types of memory media.

For purposes of illustration, programs and other executable program components such as the operating system are illustrated herein as discrete blocks, although it is recognized that such programs and components reside at various times in different storage components of the computer, and are executed by the data processor(s) of the computer.

Example Modeling Agent

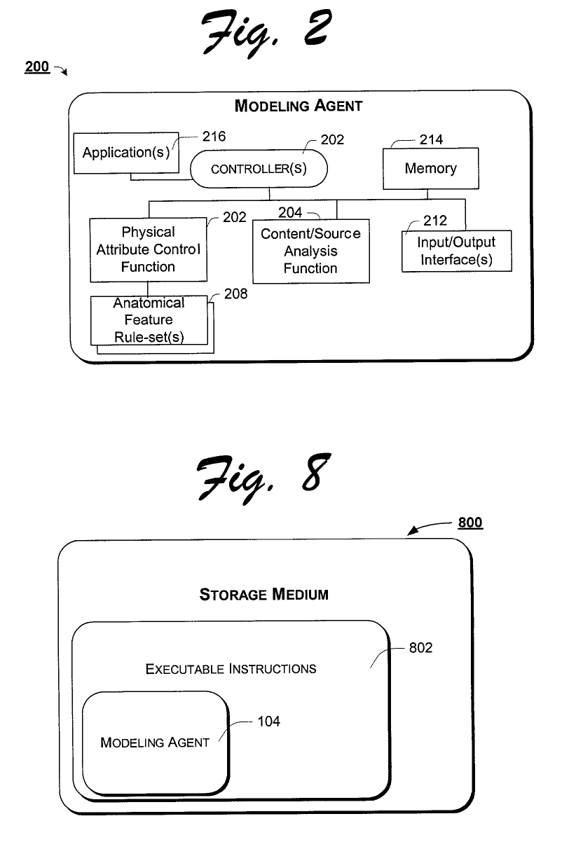

FIG. 2 illustrates a block diagram of an example modeling agent 104 incorporating the teachings of the present invention. As shown, modeling agent 104 is comprised of one or more controllers 202, physical attribute control function 204 with associated anatomical feature rule set(s) 206, content/source analysis function 208, input/output interface(s) 210, memory 212 and, optionally, one or more application(s) 214 (e.g., graphical user interface, video conferencing application, gaming application, bank teller application, etc.), coupled as shown. It will be appreciated that although depicted in FIG. 2 as a number of disparate blocks, one or more of the functional elements of the modeling agent 104 may well be combined. In this regard, modeling agents of greater or lesser complexity which iteratively jointly optimize a dynamic lexicon, segmentation and language model may well be employed without deviating from the spirit and scope of the present invention.

As alluded to above, although depicted as a separate functional element, modeling agent 104 may well be implemented as a function of a higher level application, e.g., a gaming application, a multimedia application, a video conferencing application, and the like. In this regard, controller(s) 202 of modeling agent 104 are responsive to one or more instructional commands from a parent application to selectively invoke the features (204-206) of modeling agent 104. Alternatively, modeling agent 104 may well be implemented as a stand-alone tool for modeling physical expressive communications in response to conversational input. In either case, controller(s) 202 of modeling agent 104 selectively invoke one or more of functions 204 and/or 206 to control one or more physically expressive attributes in generating a virtual character in response to human interaction with the rendered character. Thus, except as configured to effect the teachings of the present invention, controller 202 is intended to represent any of a number of alternate control systems known in the art including, but not limited to, a microprocessor, a programmable logic array (PLA), a micro-machine, an application specific integrated circuit (ASIC) and the like. In an alternate implementation, controller 202 is intended to represent a series of executable instructions to implement the control logic described above.

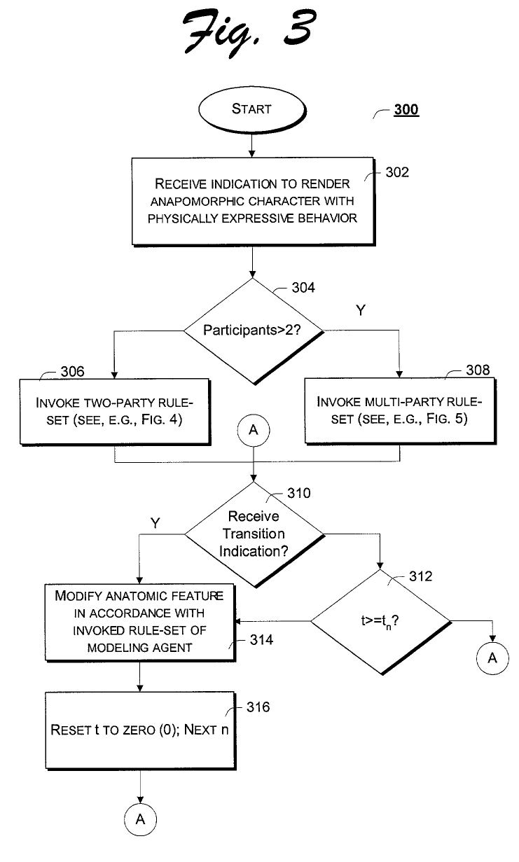

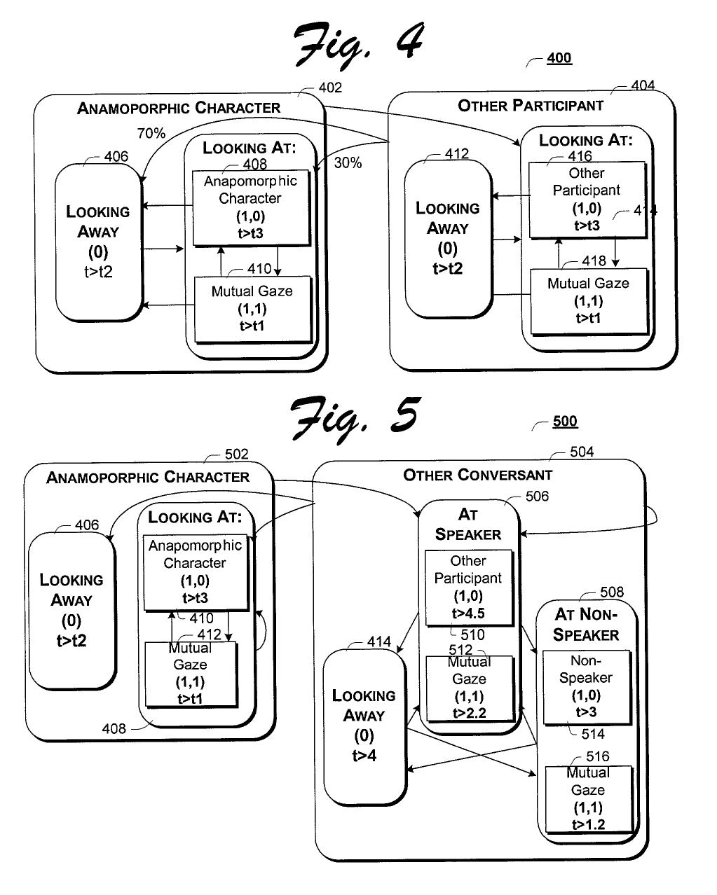

Physical attribute control function 204 controls one or more physically expressive anatomical features of a rendered character based in accordance with a scientifically developed rule-set 206 for the associated anatomical feature(s). In this regard, physical attribute control function 204 interacts with an application (local (e.g., application 214) or remote) which renders the character to provide more accurate physically expressive anatomical features. According to one implementation, physical attribute control function 204 controls an eye gaze attribute of a rendered character to mimic that of typical human eye gaze characteristics given a particular conversational situation. In accordance with this example implementation, physical attribute control function 204 periodically modifies at least the eye gaze attribute of a rendered character to look at the user (e.g., mutual gaze) or away from the gaze of the user (e.g., at another object, the mouth of the user, etc.) based on the scientifically based rule set, the context of the conversation and, if available, the perceived eye gaze of the user (e.g., from content/source analysis function 208). In addition to the foregoing, physical attribute control function 204 may also control other physically expressive attributes of the rendered character in place of, or addition to, the characters eye gaze. According to one implementation, for example, the physical attribute control function 204 causes the character to render a “nod” of the head to the user in response to shifting the eye gaze from another object to the speaker during a state of mutual gaze (e.g., state 1,1 in the hierarchical state diagrams of FIGS. 4 and 5, below).

Anatomical feature rule-set(s) 206 are selectively accessed by physical attribute control function 204 to control one or more anatomical features of a rendered character. As introduced above, anatomical feature rule-set(s) 206 are developed from scientific research of a number of relevant factors. According to one implementation, the rule-set(s) are denoted as a hierarchical state diagram (see, e.g., FIGS. 4 and 5, below). As will be discussed more fully below, physical attribute control function 204 monitors the length of time in each state in determining when to change eye gaze state, and to which state to transition.

In accordance with the illustrated example embodiment of eye gaze, rule sets 206 are developed to reflect a number of factors affecting eye gaze such as, for example, age of user(s), gender of user(s), length of conversation, conversational content, proximity of the user(s) to the display, culture of the user(s). One or more of the foregoing factors are used to develop the hierarchical state diagram used by physical attribute control function 204 to control the one or more anatomical features of the rendered character.

Content/source analysis function 208 monitors the content and/or flow of conversation and, if possible, the eye gaze features of the user(s) interacting with the rendered character for use by physical attribute control function 204. In this regard, according to one implementation, content source analysis function 208 monitors conversational content for transitional cues. A number of transitional cues may be used such as, for example, the return of the eye gaze of the speaker to the listener, a period of silence, the content of the conversation, etc. According to one implementation, for example, content/source analysis function 208 receives video input from a camera providing at least a shot of the user(s) head. Content/source analysis function 208 monitors the user(s) eye gaze behavior (e.g., looking at the rendered character, at the keyboard/mouse, at another object, etc.). These transitional cues are provided to physical attribute control function 204 which, based on the invoked rule set(s) 208, adjusts one or more physical attributes of the rendered character.

As used herein, the input/output interface(s) 210 and memory 212 are each intended to represent any of a number of I/O interface(s) and memory device(s) known in the art. I/O interface(s) 210 enable modeling agent 104 to interact with audio/video device(s), display devices, control devices (e.g., keyboard, mouse, etc.). In accordance with one example embodiment, I/O interface(s) 210 interface with the I/O interface(s) (156, 170, 184, etc.) of a host computing system 102 to interact with such devices. Memory 212 is selectively used by controller(s) 202 and or functions 204, 206 to temporarily store information required to control one or more anatomical feature(s) of a rendered character. In this regard, memory 212 is intended to represent any of a wide variety of memory devices known in the art and, thus, need not be further described here.

As introduced above, modeling agent 104 may well include one or more application(s) 214, which selectively invoke the innovative features of modeling agent 104 to render a virtual character. In this regard, application(s) 214 may include a graphical user interface (GUI) which accepts conversational input from a computer user to control the computer, providing accurate physically expressive cues and responses to the user, a gaming application, a video conferencing application, and the like. But for the interaction with and control by innovative functions 204/208 of modeling agent 104, these applications 214 are intended to represent any of a wide variety of applications which utilize rendered characters and, thus need not be further described here.

Example Operation and Implementation

Having introduced the functional and architectural elements of the present invention with reference to FIGS. 1 and 2, an example operation and implementation will be further developed with reference to FIGS. 3-8. For ease of illustration, and not limitation, the discussion of the example operational and implementation details will be presented with continued reference to FIGS. 1 and 2, and in accordance with the example implementation of controlling eye gaze of the anthropomorphic character. It is to be appreciated, however, that the teachings of the present invention extend beyond the scope of controlling character eye gaze to controlling any of a number of physically expressive anatomical features of a character. Such alternate embodiments are included within the spirit and scope of the present invention.

FIG. 3 illustrates an example method of controlling one or more physically expressive anatomical features of an anthropomorphic character in response to conversational content based, at least in part, on a scientifically developed model of human physically expressive behavior. In accordance with the illustrated example embodiment of FIG. 3, the method begins with block 302 wherein an indication to render a virtual character with physically expressive behavior is received. In accordance with the teachings of the present invention, controller(s) 202 receives the indication from an application, e.g., application 214 and/or a remote application executing on a communicatively coupled computer system (e.g., 102).

In response, modeling agent 104 determines the number of conversational participants, block 304. According to the example implementation, controller 202 selectively invokes an instance of physical attribute control function 204 which, based on the number of conversation participants (or, conversants) selects one or more appropriate anatomical feature rule-set(s) 208. According to one implementation, modeling agent 104 identifies the number of conversants using content/source analysis function 208, based on audio and/or video information.

If, in block 304, two or fewer participants are identified (i.e., the character and a user, such as in a gaming application, a GUI, and the like) a two party rule-set 208 is selectively invoked by physical attribute control function 204. That is, physical attribute control function 204 controls one or more anatomical features of the rendered character in accordance with the selected rule-set 208. If, alternatively, multiple parties are identified, physical attribute control function 204 selectively invokes a multi-party rule set, block 308.

In either case, once the appropriate rule set(s) 206 are invoked, content/source analysis function 208 monitors the conversational content and/or user characteristics for transition indications, block 310. As described above, content/source analysis function 208 monitors audio input of the conversation for breaks, or silences, denoting a potential transition point of speakers. In addition, content/source analysis function 208 may well receive video content input of the user (participant) from which the eye gaze behavior of the user is provided to physical attribute control function 204. In addition to monitoring the conversational flow, modeling agent 104 monitors the time within the current state of the eye gaze model 206 as an additional indicator of when to change state, block 312.

If a transition indication is received (e.g., block 310) or the time within a particular state has elapsed (e.g., block 312), physical attribute control function 204 issues instructions to modify the associated anatomical feature(s) of the rendered character, in accordance with the invoked rule set(s) 206 of modeling agent 104. In accordance with the illustrated example embodiment, physical attribute control function 204 issues instructions to modify at least the eye gaze of the rendered character in accordance with the invoked eye gaze model. In addition, depending on the state into which the model is transitioning (e.g., into that of mutual gaze), physical attribute control function 204 may also issue instructions to have the rendered character provide the user (participant) with a nod. Once the next state is entered, the state timer (e.g., a counter within physical attribute control function) is reset to zero to count the time within the current state, block 316. As will be described in FIGS. 4 and 5, the length of time within each state depends on the state, i.e., time within the mutual gaze state is typically less than that of looking away. This variation is state times is reflected in the flow chart of FIG. 3, as well as the state diagrams of FIGS. 4 and 5, as tₙ.

Having introduced the general operation of modeling agent 104 with reference to FIG. 3, example rule set(s) 206 are presented with reference to FIGS. 4 and 5. As introduced above, modeling agent 104 utilizes hierarchical state diagrams to control the physically expressive anatomical feature(s) of a rendered character. In accordance with the illustrated example embodiment, hierarchical state diagrams controlling at least the eye gaze behavior of a rendered character are presented with reference to FIGS. 4 and 5, below. It is to be appreciated, however, that alternate/additional models may well be used to control other/additional anatomical features without deviating from the spirit and scope of the present invention. Indeed, such models are anticipated within the scope and spirit of the present invention.

FIGS. 4 and 5 each illustrate example hierarchical state diagrams used by modeling agent 104 to control one or more physical expressive attributes of a virtual character, in accordance with one implementation of the present invention. In accordance with one aspect of the present invention, FIG. 4 illustrates an example hierarchical state diagram for controlling eye gaze behavior of a virtual character engaged in a two-party conversation. FIG. 5 illustrates an example hierarchical state diagram for controlling eye gaze behavior of a virtual character engaged in a multi-party conversation, in accordance with another aspect of the present invention. In accordance with the illustrated example implementation of controlling eye gaze behavior, the state diagrams of FIGS. 4 and 5 represent the result of scientific research into human eye gaze behavior as a form of non-verbal communication. In this regard, the state diagrams of FIGS. 4 and 5 are selectively invoked by modeling agent 104 to control the eye gaze physically expressive attribute of a virtual character to accurately “mimic” human behavior given the same conversational content and flow. It will be appreciated, based on the teachings of the present invention, that other state diagrams may well be scientifically developed and implemented within modeling agent 104 to model other physically expressive communication, verbal communication, and the like, without deviating from the scope and spirit of the present invention. Indeed, such extensions of the present invention are anticipated.

Turning to FIG. 4, an example state diagram for controlling eye gaze behavior of a virtual character engaged in a two-party (i.e., one-on-one) conversation is presented, in accordance with one example embodiment of the present invention. In accordance with the illustrative example of FIG. 4, diagram 400 is presented comprising two main states 402 and 404 reflecting which participant (e.g., the character (402) or user (404)) is speaking. Within each of the states (402, 404) are additional, sub-states (406-410 and 412-418, respectively) which reflect the eye gaze of each of the participants. Each of the sub-states 406-418 are labeled with either one or two numbers. The zero (0) state (406, 412) indicates that the character is gazing away from the other. State (1,0) (408, 416) indicates that the character is looking at the other, but that the other is looking away from the character. State (1,1) (410,418) denotes that the character is looking at the other while the other is looking at the character, i.e., a state of mutual gaze. In accordance with the illustrated example embodiment, the character always looks at the other when the other begins to speak. When the character begins to speak, however, the character will only look at the other only some of the time, e.g., 30%.

According to one example implementation, the decision to transition the character's eye gaze is triggered primarily by the passing of time within the current sub-state (406-418). That is, physical attribute control function 204 monitors the time within each sub-state as a primary indicator of when to transition to the next state. As provided above, however, a number of alternate indicators may also be used by control function 204 to invoke a state transition, e.g., conversational content, perceived eye gaze of the user, etc.). One exception is the occurrence and timing of “vertical” transitions, i.e., the transitions between states 1,0 and 1,1. According to one implementation, transition between these states depend solely on the other participant glancing at, or away from, the character. That is, such transitions depend solely on the secondary indications received from content/source analysis function 208.

As denoted in FIG. 4 (and FIG. 5, for that matter), the passing of time in a particular sub-state measured by physical attribute control function 204 is denoted as t. Each time a new sub-state is entered, t is set to zero (0), and a transition time (tₙ) is chosen. In accordance with the teachings of the present invention, the transition times are chosen based on scientific research of typical expressive behavior of the particular anatomic feature. Physical attribute control function 204 triggers a transition when t surpasses the transition time tₙ.

With reference to FIG. 5, an example state diagram for controlling eye gaze behavior of a virtual character engaged in a multi-party conversation is presented, in accordance with the teachings of the present invention. As shown, state diagram 500 is similar to that of the two-party diagram 400, but provides for gazing at other non-speaking conversant(s) 508. In addition, a new transition is needed, i.e., from “other” speaking back to itself. In accordance with the illustrated example embodiment, there is a 60% chance that the next gaze will be at the speaker, a 30% chance of looking at another non-speaker, and a 10% chance of looking away from anyone.

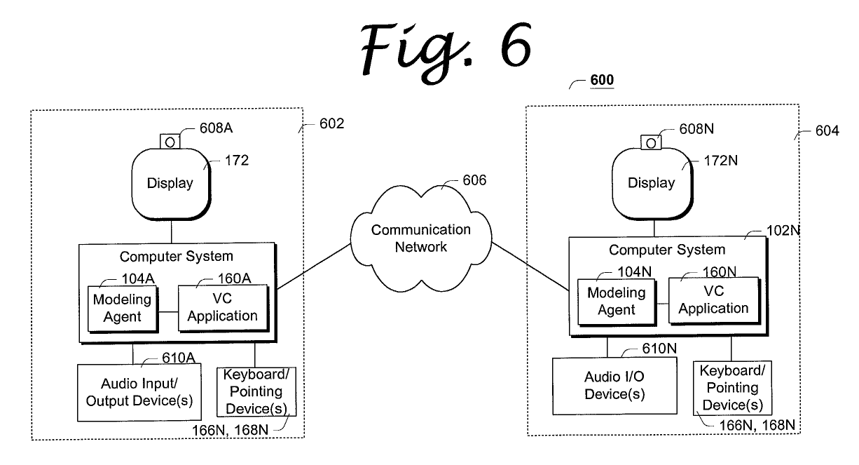

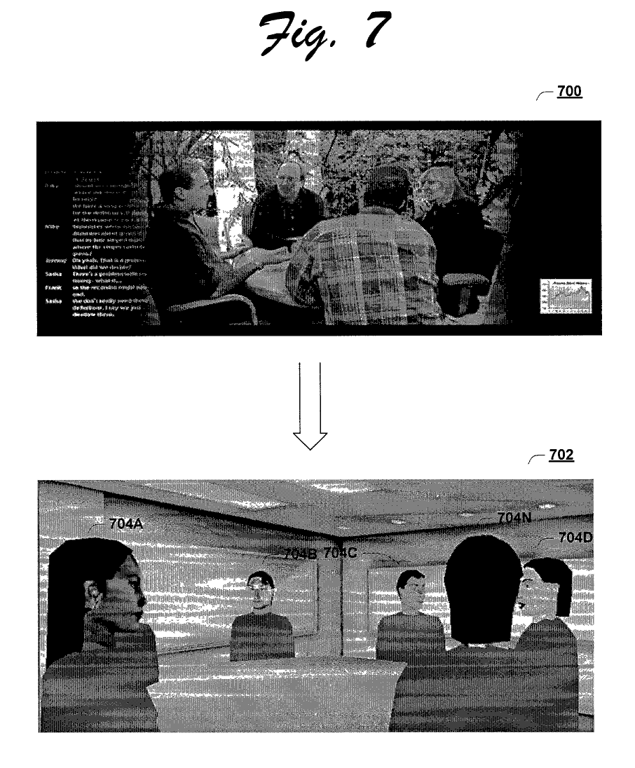

Having introduced an example operational embodiment of modeling agent 104 with reference to FIGS. 3-5, an example implementation will be discussed with reference to FIGS. 6 and 7, presented below. More specifically, the operation of innovative modeling agent 104 will be further developed within the context of a multi-party video conferencing session. More specifically, FIG. 6 depicts a block diagram of an example conferencing system 600 incorporating the teachings of the present invention, while FIG. 7 illustrates an example display incorporating a rendered character(s) utilizing the eye gaze features of the present invention. Again, FIGS. 6 and 7 are presented as but an example implementation of the teachings of the present invention, as control of other/additional anatomical features may well be implemented in accordance with the teachings of the present invention.

FIG. 6 illustrates a block diagram of an example video conferencing system 600, incorporating the teachings of the present invention. As shown, video conferencing system 600 is comprised of two video conferencing centers 602, 604 communicatively coupled by a communication channel, e.g., through a communication network 606. As shown, each of the centers 602 and 604 include a computing system (e.g., 102) including a modeling agent 104 and a video conferencing (VC) application 160. In addition, each of the centers include 1 display device 172, a video camera 608, audio input/output (I/O) device(s) 610 and, optionally a keyboard/pointing device(s) 166, 168 to control one or more aspects of the video conferencing system. In accordance with one implementation of the present invention, rather than providing each of the conference participants (e.g., center users) with a video image of the other participant(s), system 600 provides each with a rendered character of the other. Moreover, in accordance with the teachings of the present invention, modeling agent 104 controls one or more anatomical features of the rendered character to provide accurate physically expressive behavior. But for incorporation of modeling agent 104, video conferencing system 600 is intended to represent any of a number of conferencing systems known in the art. In this regard, but for modeling agent 104, the elemental components of conferencing system 600 are well known, and need not be discussed further. Moreover, it should be appreciated that not every video conference center (e.g., 602 or 604) need include the innovative modeling agent 104 to interact with a center populated with the agent. That is, conferencing centers populated with the modeling agent 104 may well function with non-populated centers.

FIG. 7 graphically illustrates an example display (e.g., 172) from a video conference center (602, 604) engaged in a video conferencing session incorporating the teachings of the present invention. More particularly, view 700 displays a photographic image of the actual video conference participants, while view 702 displays the anthropomorphic agents of the actual conference participants. That is, a number of virtual characters (704A . . . N) are displayed which represent an associated number of conference participants. In accordance with one example implementation, each of the conference participants are utilizing a conferencing center incorporating modeling agent 104, which is controlling one or more anatomical features of the associated rendered character. The result is a video conference display of rendered characters (proxies, if you will), each with anatomical features which accurately reflect typical human physically expressive behavior.

Alternate Embodiments

FIG. 8 is a block diagram of a storage medium having stored thereon a plurality of instructions including instructions to implement the innovative modeling agent 104 of the present invention, according to yet another embodiment of the present invention. In general, FIG. 8 illustrates a storage medium/device 800 having stored thereon a plurality of executable instructions 802 including at least a subset of which that, when executed, implement the innovative modeling agent 104 of the present invention. When executed by a processor of a host system, the executable instructions 802 implement the modeling agent 104 to control one or more physically expressive attributes of a rendered character.

As used herein, storage medium 800 is intended to represent any of a number of storage devices and/or storage media known to those skilled in the art such as, for example, volatile memory devices, non-volatile memory devices, magnetic storage media, optical storage media, and the like. Similarly, the executable instructions are intended to reflect any of a number of software languages known in the art such as, for example, C++, Visual Basic, Hypertext Markup Language (HTML), Java, extensible Markup Language (XML), and the like. Moreover, it is to be appreciated that the storage medium/device 800 need not be co-located with any host system. That is, storage medium/device 800 may well reside within a remote server communicatively coupled to and accessible by an executing system. Accordingly, the software implementation of FIG. 8 is to be regarded as illustrative, as alternate storage media and software embodiments are anticipated within the spirit and scope of the present invention.

Although the invention has been described in language specific to structural features and/or methodological steps, it is to be understood that the invention defined in the appended claims is not necessarily limited to the specific features or steps described. Rather, the specific features and steps are disclosed as exemplary forms of implementing the claimed invention.

1. A method comprising:
rendering a character to interface with at least a user; and
controlling an anatomical feature of the character based, at least in part, on a scientifically-based model of physically expressive behavior for the anatomical feature in response to interaction with the user.

2. A method according to claim 1, wherein the character engages or is engaged by the at least one user in a conversation.

3. A method according to claim 1, wherein control of the anatomical feature of the character is based, at least in part, on eye gaze input of the at least one user.

4. A method according to claim 1, wherein the anatomical feature is an eye gaze.

5. A method according to claim 4, wherein controlling an anatomical feature comprises:
identifying a speaker in a conversation;
directing the eye gaze of the character to the identified speaker during select times of the conversation in accordance with the scientifically-based model of physically expressive behavior;

6. A method according to claim 5, further comprising:
directing the eye gaze of the character away from the identified speaker during select times of the conversation in accordance with the scientifically-based model of physically expressive behavior.

7. A method according to claim 5, wherein the identified speaker is the character, the method further comprising:
directing the eye gaze of the character to another during select times of the conversation, in accordance with the scientifically-based model of physically expressive behavior.

8. A method according to claim 7, wherein another is one or more of another virtual character, a local user of an application which rendered the character, a remote user of an application which rendered the character, and the like.

9. A method according to claim 8, wherein the application is one or more of a financial institution kiosk, a gaming application, a video conferencing application, a virtual newscaster, a virtual travel agent, and/or a virtual teacher in an educational application.

10. A method according to claim 8, wherein the virtual character or the another virtual character represent a proxy for associated user(s).

11. A method according to claim 5, wherein select times of the conversation are dynamically determined based, at least in part, on a number of conversation participants, which participant is speaking, how long the participant has been speaking, how long it has been since the eye gaze of the character was directed at another, and the like.

12. A method according to claim 1, wherein control of the one or more anatomical features is based, at least in part, on one or more of a number of conversation participants, which participant is speaking, how long the participant has been speaking, time elapsed in a current eye gaze state, and the like.

13. A storage medium comprising a plurality of executable instructions that, when executed, implement a method according to claim 1.

14. A computing system comprising:
a storage medium having stored therein a plurality of instructions; and
an execution unit, communicatively coupled to the storage medium, to execute at least a subset of the instructions stored therein to implement a method according to claim 1.

15. A computing system comprising:
a user input/output system including a display device to render a virtual character; and
a modeling agent, coupled to the user I/O system, to control one or more anatomical features of a rendered virtual character based, at least in part, on a scientifically-based model of physically expressive behavior of the anatomical feature, and in response to user interaction with the rendered character.

16. A computing system according to claim 15, wherein the user interaction with the rendered character is in speech form.

17. A computing system according to claim 15, wherein the rendered character engages, or is engaged by, a user of the computing system in conversation.

18. A computing system according to claim 17, wherein the user utilizes the rendered character as a virtual proxy in communication with another.

19. A computing system according to claim 15, wherein the modeling agent identifies a speaker in a conversation and, at select times, directs an eye gaze of the rendered character to that of the speaker, in accordance with the scientifically-based model of physically expressive behavior.

20. A computing system according to claim 15, wherein the modeling agent identifies other conversation participants and, at select times, directs an eye gaze of the rendered character to that of the other conversation participants, in accordance with the scientifically based model of physically expressive behavior.

21. A computing system according to claim 15, wherein the input/output system further comprises:
a video camera, in communication with the modeling agent, to provide the modeling agent with eye gaze information of the user.

22. A computing system according to claim 21, wherein the modeling agent receives eye gaze information about other conversation participants from remote computing systems.

23. A computing system according to claim 22, wherein the computing systems are participating in a video conferencing session, wherein the rendered character is a proxy for the user(s).
